(19) United States
(12) Patent Application Publication
(10) Pub. No.: US 2007/0183154 A1
(43) Pub. Date: Aug. 9, 2007

(54) Sealed cover for recessed lighting fixture

(76) Inventor: Christopher Mark Robson, Miami, FL (US)

Correspondence Address: C. MARK ROBSON, 19860 NE 24TH COURT, MIAMI, FL, 33180-2147, US

(21) Appl. No.: 11/347,033

(22) Filed: Feb. 4, 2006

(51) Int. Cl. F21V 29/00

(52) U.S. Cl. 362/267

(57) ABSTRACT

The present invention relates to a cover for a recessed light fixture, having a housing composed of heat-tolerant material, and having visible trim ring (12), and a means for retaining said cover to said fixture (10). Light generated by the recessed light fixture will pass through the lens (14), which may be transparent, translucent, or colored. The present invention is sized to fit within the baffle of a preexisting recessed light fixture (15), to which the present invention may be frictionally engaged, and over the outer trim of such a fixture (17), to which the present invention will form an airtight seal through the use of a seal ring (16). The present invention seeks to promote energy efficiency by providing an airtight barrier which inhibits the passage of conditioned (furnace-heated or air conditioner-cooled) air through the recessed light fixture and out of the living space. Energy efficiency is also promoted by encouraging (though not necessitating) conversion from incandescent bulbs to compact fluorescent bulbs. Further, the airtight barrier has the desirable effect of prohibiting the movement of insects through the recessed light fixture and into the living space. The present invention can be easily installed without tools or special skill, and can be easily removed to allow for bulb replacement. It can be manufactured in varying shapes and sizes, including sizes conforming to standard recessed light fixtures having circular openings with 4-inch and 6-inch diameters, and with tapered and non-tapered baffles.

### CROSS-REFERENCE TO RELATED APPLICATIONS

Not applicable.

### STATEMENT REGARDING FEDERALLY SPONSORED RESEARCH AND DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to a cover, sized to fit within and engage the baffle of a recessed lighting fixture, and extending to the outer rim of said fixture, forming an airtight seal thereupon.

A recessed light fixture (referred to herein as a “RLF”) is one housed within a can located within an attic (in the case of a ceiling-mounted RLF), with only the trim and light bulb generally visible beneath. RLF popularity from the 1960s to the present derive from their unobtrusiveness into the living space, aesthetics (or lack thereof), and their utility in allowing light to be focused in a desired area

RLFs pose energy-loss concerns: because RLFs are particularly pervasive in older homes with outmoded attic insulation, and because the very nature of a RLF is to perforate the barrier between the attic and the living space below, a situation is created whereby interior climate control efficiency is sacrificed: in the winter, furnace-heated warm air rises to the ceiling and is drawn through the RLF out of the living space, decreasing furnace efficiency and increasing home-heating costs. In warm weather, air conditioned cool air is similarly drawn away from the living space, thereby decreasing air conditioner efficiency and increasing electricity costs. In either climate, the end result is the same: a situation where energy costs are inflated. Concerns surrounding such energy inefficiency intensify proportionately with a rise in energy prices.

In addition to energy loss due to design, RLFs often fail to take advantage of efficiencies resulting from advances in lighting technology: because the light bulb used in an RLF is visible (though it may be recessed), RLFs are generally not good candidates for higher-efficiency compact fluorescent bulbs (which became widely available in the late 1990s, and were not contemplated at the time of installation of many RLFs currently in use worldwide). According to an Aug. 20, 2001 press release from the United States Department of Energy, a compact fluorescent bulbs (referred to herein as a “CFB”) uses about one-fourth less energy and lasts up to 10 times longer than a typical incandescent bulb, and a homeowner replacing 25 percent of their most-used lights with CFBs can save about 50 percent on their lighting bill.

An Oct. 31, 2005 article in Time Magazine noted that an incandescent 100-watt bulb costs $35.04 in power over a three-year period, while a 23-watt CFB costs $8.06. While the cost of a CFB is higher ($11 compared with 75-cents for an incandescent), it lasts more than 13 times as long. As such, Time Magazine indicated that the total annual savings for switching four incandescent 100-watt bulbs, with four 23-watt CFBs, counting the costs of the bulbs, would be $27.33 (all figures current as of the date of the October 2005 article).

The vastly longer life of CFBs compared to incandescent bulbs is of particular importance when it comes to a ceiling-mounted RLF, as the bulbs in such fixtures are particularly difficult and potentially dangerous to replace.

In addition to the deleterious energy effects of RLFs outlined above, RLFs also result in an undesirable entry point into the living space for insects and other pests. Though an occupant may do everything possible to seal windows, doors and walls against such entry, RLFs are less easy to secure. If the RLF is not itself sealed, such insects can easily traverse the barrier between the unprotected attic and the living space below.

The present invention seeks to promote savings to the user by halting the loss of energy inherent to the design of the RLF while simultaneously promoting the use of higher-efficiency lighting. The result is a two-pronged response to increased energy costs. Additionally, the appearance of the RLF is aesthetically improved by streamlining the appearance of the RLF, and by providing cover and diffusion of the harsh appearance of CFBs, should they be selected for use in the RLF.

U.S. Pat. No. 6,286,980 issued to Meyer and titled “recessed light protection cover” discloses a cover, but for the recessed portion of the RLF (to prevent the build up of thermal insulation around a fixture in the attic), and not on the visible portion of the RLF, as disclosed by the present invention.

U.S. Pat. Application No. 20030186017 filed by Stockton discloses a RLF insert which prevents paint or drywall texture from entering and adhering to the fixture, but is not intended for permanent use with an RLF, and is not intended for use during operation of the RLF.

Similarly, U.S. Pat. Application No. 20050078474 filed by Whitfield discloses a cover to protect a RLF from exposure to fluid during painting or other ceiling treatments by having a shield sized to fit over a baffle and an outer trim of a RLF.

U.S. Pat. Application No. 20050168989 (the “989 Application”) filed by Nate discloses an attachment for retaining one or more lenses in position over a RLF. The 989 Application does not describe an airtight cover, nor does it describe a cover intended for use with energy saving bulbs. Further, the 989 Application does not contemplate functionality beyond aesthetics, it does not conceal the trim of a pre-existing RLF, and its design is completely dissimilar to the present invention.

The prior art fails to disclose a RLF cover which provides an airtight seal around the visible portion of said RLF, designed to streamline the appearance of the RLF and permit conversion to energy-saving light sources, while simultaneously preventing energy loss and insect entry through the opening required for installation and operation of the RLF. None of the above-noted patents or patent applications, taken either singly or combination, are seen to disclose the specific arrangement concepts disclosed by the present invention.

### BRIEF SUMMARY OF THE INVENTION

It is therefore an object of the present invention to provide a cover for a RLF which provides an airtight seal between said fixture and the inhabitable space below.

Another object of the present invention is to promote energy conservation by preventing energy loss from the living space, through the RLF.

Still another object of the present invention is to promote energy conservation by promoting conversion of the light source in the RLF from incandescent bulbs to CFBs, a conversion which is made more appealing where the CFB is concealed by the cover.

Yet another object of the present invention is to furnish a barrier around the RLF which impedes the ability of pests and insects to traverse from attic space into living space.

A final object of the present invention is to provide an aesthetic improvement to RLFs by creating a smooth and uniform appearance to the visible portion of the fixture, and concealing aspects of the RLF which are do not appeal to the user (e.g. a discolored RLF trim ring or black baffle).

With these and other objects in view, which may more readily appear as the nature of the invention is better understood, the present invention consists in the novel combination and arrangement of parts hereinafter more fully described, illustrated and claimed with reference being made to the attached drawings.

By the present invention, a cover providing an airtight seal around a RLF is disclosed.

The present invention is directed toward an attachment for a RLF that can be installed without special skills, tools, dexterity or physical strength.

More specifically, the present invention is directed toward a cover for use with RLFs currently installed and in use, which have a housing within which the light source is recessed. The cover provides an airtight seal of the RLF, and can employ a lens designed to soften light from a CFB, should a CFB be chosen for use in the RLF.

The preferred embodiment of the present invention comprises generally a lens, an airtight seal ring, and a housing holding both in place over the RLF.

The housing of the preferred embodiment of the present invention fits inside the baffle of a RLF, and includes a means for retaining the attachment body within the housing of said RLF. The attachment body includes a means of retaining the lens, and an outer trim ring visible after installation over an existing RLF such that any trim of the existing RLF is partially or completely obscured from view by the trim of the present invention. The outer circumference of the trim ring of the attachment body will be in direct contact with the RLF trim. The trim ring of the attachment body will be in contact with the airtight seal ring, which will in turn be in contact with the RLF trim, providing the desired airtight seal. In the preferred embodiment, the means for connecting the present invention to the housing of an existing RLF requires the attachment body to be of such diameter that it may be push-fit and secured upon the RLF housing.

The attachment body of the present invention may be made out of any material that is known in the art, or yet to be developed, but the preferred embodiment of the present invention contemplates a metal, plastic, or similarly rigid and heat-tolerant material.

The lens in the present invention may similarly be made out of any material that is known in the art, or yet to be developed, but the preferred embodiment of the present invention contemplates a heat-tolerant lens which can be composed of plastic or glass, which can be transparent or translucent, and which can be clear or colored. Production of multiple varieties of lenses is contemplated, each being interchangeable to meet the needs and desires of the user.

The inner airtight seal ring of the present invention may also be made out of any material known in the art or yet to be developed, but the preferred embodiment of the present invention contemplates an o-ring made of heat-tolerant foam, silicone, or other flexible material that will allow for an airtight fit against a slightly uneven surface, and which will have a sufficiently high melting point to resist adhesion or warping as a result of heat generated from extended use of the RLF. Where an iron-based trim is employed in the RLF, the possibility of employing a seal ring composed of magnetized iron is also contemplated.

### BRIEF DESCRIPTION OF THE SEVERAL VIEWS OF THE DRAWING

FIG. 1 is a perspective view of a preferred embodiment of the present invention viewed from a slightly inferior angle;

FIG. 2 is an end view depicting the features of the present invention which will be concealed after installation over a pre-existing RLF;

FIG. 3 is an end view depicting the features of the present invention which will be visible after installation;

FIG. 4 is a perspective view of the present invention from a slightly elevated angle;

FIG. 5 is a cross-sectional view of a section of the present invention depicting the interaction of the lens and seal ring with the housing, and the profile of the retaining clip of said housing;

FIG. 6 is a perspective view of the present invention in the process of installation over a pre-existing RLF;

FIG. 7 is a perspective view of the present invention following installation.

### DETAILED DESCRIPTION OF THE INVENTION

The present invention allows for the quick and simple installation of an airtight cover over a RLF without special skills, tools, dexterity or physical strength. In its most basic form, the present invention consists of an insert that is engaged with the RLF at three points, namely (i) the housing of the present invention frictionally engaged with the inner surface of the RLF baffle, (ii) the outer trim of the present invention physically engaged with the outer trim of the RLF, and (iii) the airtight seal ring adhesively engaged with the trim ring of the present invention, and physically engaged with the outer trim of the existing RLF. As contained herein, the present invention is described with reference to a ceiling-mounted RLF, though it is to be understood that use with other fixtures having similarly defined openings is expressly contemplated.

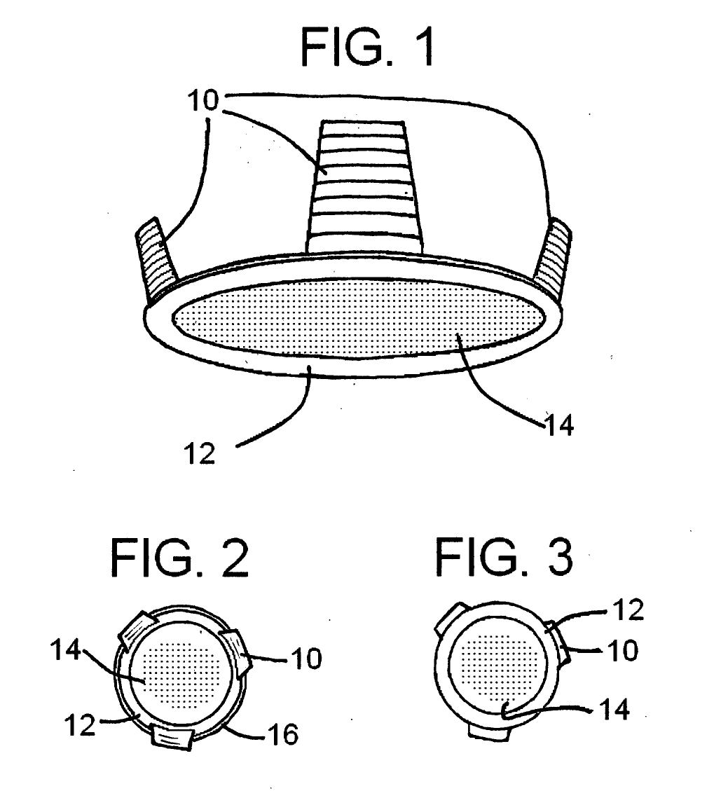

FIG. 1 is a perspective view from the underside of the present invention depicting the retaining clips of the housing 10, the trim component of the housing 12, and the lens 14. The trim ring 12 is designed to partially or fully obscure the trim of an existing RLF (not pictured), and be in direct physical contact therewith. The retaining clips 10 are sized and angled such that they will frictionally engage the ridged baffle of the RLF, and secure the present invention thereto. In this particular embodiment, three retaining clips 10 are depicted as the means of retention, though any number of such clips of varying size and shape could be substituted, as could wires, hooks, springs, screw-threading, male-female dimples or other means known in the art or yet to be developed.

The inner circumference of trim 12 is in contact with the outer surface of lens 14, which rests directly on said trim 12. In this particular embodiment, a translucent flat circular lens is contemplated, though any tint, size, shape or color of lens may be incorporated, as could a directional lens or a lens resting in a directional housing (ex. ‘eyeball’ housing).

FIG. 2 is an end view of the top of the present invention, which will face and be in physical contact with the existing RLF (not pictured). Visible from this view are the retaining clips of the housing 10, the lens 14, the seal ring 16, and the side of the trim ring 12 that will not be visible after installation over the RLF.

FIG. 3 is an end view of the bottom of the present invention, which will be visible after installation over the existing RLF (not pictured). Visible in FIG. 3 are the lens 14, the trim ring 12, and the retaining clips of the housing 10, which are partially obscured by trim ring 12. The seal ring 16 is not visible from this perspective.

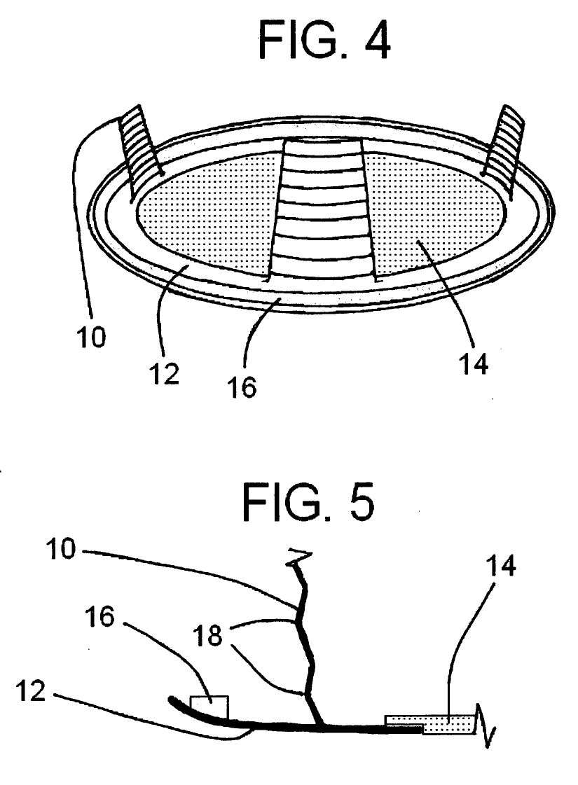

FIG. 4 is a perspective view from the upper side of the present invention depicting the retaining clips of the housing 10, the trim component of the housing 12, the lens 14, and the seal ring 16, which is adhesively engaged to the trim 12, and which will be in direct contact with the trim of the pre-existing RLF 17 (not pictured).

The cross-sectional view of the preferred embodiment of the present invention depicted in FIG. 5 shows the protrusions 18 on each retaining clip 10, designed to frictionally engage the surface of a ridged RLF baffle 15. The lens 14 rests on the trim of the housing 12. The seal ring 16 is adhesively engaged to the trim 12, and when installed will be concurrently in contact with the RLF's trim ring 17.

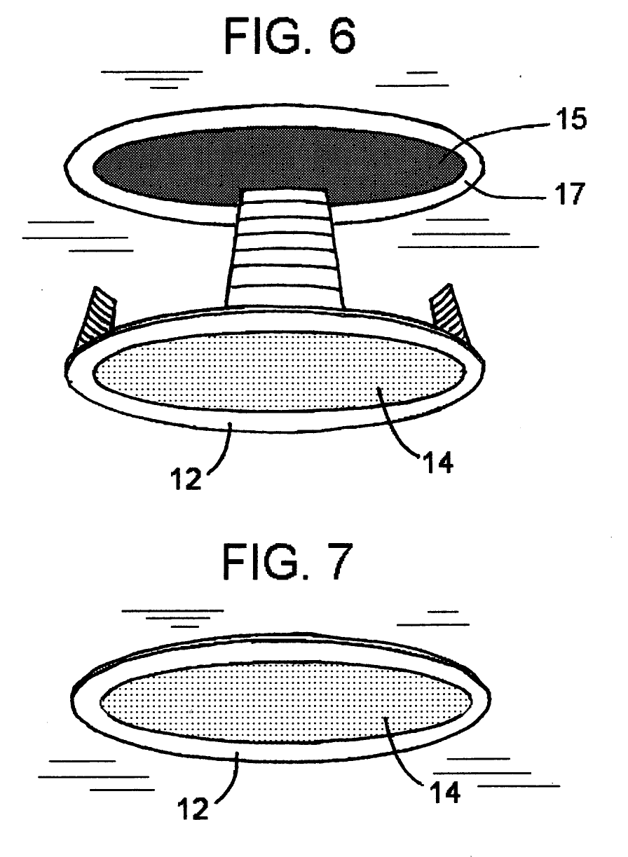

FIG. 6 is a perspective view depicting installation of the present invention over a pre-existing RLF. During installation, each retaining clip 10 is bent inward to allow entry into the trim ring of the RLF 17. Once past said RLF trim 17, the retaining clip 10 is allowed to make frictional contact with the RLF baffle 15, and is push fit to secure the retaining clip 10 against the surface of the RLF baffle 15 until such point as seal ring 16 is in contact with RLF trim 17.

Due to the fact that a RLF can have a baffle 15 and trim 17 ranging in size and shape, it is recognized that the present invention can be similarly designed and configured to cover RLFs of variable size and shape.

FIG. 7 depicts the present invention after the completion of installation. Here, each retaining clip 10 (not visible) is frictionally engaged with the RLF baffle 15 (not visible), the outer circumference of cover trim 12 is in contact with RLF trim 17 (not visible), and the seal ring 16 (not visible) is in contact with the RLF trim 17 (not visible), forming the desired airtight seal. Light from the RLF is projected through the lens 14.

The body of the present invention, which in the preferred embodiment is composed of the trim ring 12 and retaining clips 10, is preferably made of a heat-tolerant metal, alloy or plastic.

Although various embodiments of the present invention have been disclosed here for purposes of illustration, it should be understood that a variety of changes, modifications and substitutions may be incorporated without departing from either the spirit or scope of the present invention. For example, a different size, shape, or pitch of the baffle of the RLF intended for coverage by the present invention, would necessitate a similar modification to attain the objectives of the present invention. Thus, the scope of the present invention should be determined by the appended claims and their legal equivalents, rather than by the examples given.

What is claimed:

1. A cover for sealing a pre-existing recessed light fixture having a defined opening, the cover comprising:
(a) a lens allowing substantially for transmission of light from said fixture,
(b) a seal to prevent the transmission of air or matter from the region enclosed by the seal to the region beyond said seal, and
(c) a housing for retaining the lens and the seal in place over said fixture, whereby light is permitted to be transmitted through the cover, while air and matter are substantially prevented from traversing said cover.

2. The cover of claim 1, wherein the housing is made of heat-tolerant material.

3. The cover of claim 2, wherein said housing has flexible clips tapered to promote frictional engagement with said fixture, taking into consideration, among other factors, the size, shape, texture and pitch of the baffle of said fixture.

4. The cover of claim 2, wherein said housing has hooks capable of securing the cover by engaging the top of the baffle of said fixture.

5. The cover of claim 2, wherein said housing has magnetic components capable of securing the cover to said fixture.

6. The cover of claim 2, wherein said housing has adhesive components capable of securing the cover to said fixture.

7. The cover of claim 2, wherein said housing has extensions equipped with malleable tips capable of frictionally engaging the baffle of said fixture, taking into consideration, among other factors, the size, shape, texture and pitch of the baffle of said fixture.

8. The cover of claim 2, wherein said housing is made from a material selected from the group consisting of plastic, metal, and ceramic.

9. The housing of claim 8, wherein the plastic is selected from the group consisting of: polyethylene, polypropylene, polycarbonate, perflueroalkoxy, polytetrafluoroethylene, and acrylonitrile butadiene styrene.

10. The cover of claim 1, wherein said lens is composed of a rigid, heat tolerant material.

12. The cover of claim 10, wherein the lens is translucent, allowing for the softening of light from a fluorescent source used in said fixture.

13. The cover of claim 10, wherein the lens is transparent.

14. The cover of claim 10, wherein the lens is made from a material selected from the group consisting of tempered glass, plastic, and ceramic.

15. The cover of claim 1, wherein the seal is comprised of a heat tolerant material.

16. The cover of claim 15, wherein the heat tolerant material is selected from the group consisting of: metal, magnetized iron, polystyrene, polyisoprene, isoprene, chlorosulfonated polyethylene, organic silicone polymer, isobutylene.

17. A method for covering a fixture having a defined opening, the method comprising: press-fitting a cover into said defined opening such that said insert frictionally engages the inner surface defining said defined opening, the said cover substantially covering the visible aspects of said fixture.

18. In a lighting fixture of the type having a recessed can, a defined opening containing the light source and a visible trim, the improvement wherein said fixture is sealed by a cover comprised of a lens, a seal, and a housing which retains the lens and the seal in place over said fixture.

19. The cover of claim 18, wherein the housing is made from a material selected from the group consisting of plastic, metal, and ceramic.

20. The cover of claim 18, wherein said lens is composed of a material selected from the group consisting of transparent tempered glass, transparent glass, transparent plastic, translucent tempered glass, translucent glass, translucent plastic, colored tempered glass, colored glass, colored plastic.
